(19) United States
(12) Patent Application Publication
(10) Pub. No.: US 2019/0228103 A1
(43) Pub. Date: Jul. 25, 2019

(54) Content-Based Filtering of Elements

(71) Applicant: Microsoft Technology Licensing, LLC, Redmond, WA (US)

(72) Inventors: Adam Edward SHIREY, Renton, WA (US); Anna Swanson BERTIGER, Seattle, WA (US); Aaron Joseph MERRILL, Covington, WA (US)

(73) Assignee: Microsoft Technology Licensing, LLC, Redmond, WA (US)

(21) Appl. No.: 15/875,076

(22) Filed: Jan. 19, 2018

(51) Int. Cl. G06F 17/30; G06K 9/62; G06F 17/21; G06K 9/00; H04L 29/08

(52) U.S. Cl. CPC G06F 17/30887; G06K 9/6278; H04L 67/025; G06K 9/00469; G06F 17/30905; G06F 17/218

(57) ABSTRACT

Described herein is a system and method for filtering content of a document (e.g., web page). Based on content of an element of a received document, using a filter a model is applied (e.g., naïve Bayes classifier) to calculate an approximate probability or score that the element comprises non-desired content. Based upon the calculated approximate probability or score, a determination is made that the element comprises non-desired content (e.g., probability greater than or equal to a threshold). An action is taken with respect to the element based upon the determination that the element comprises non-desired content. The action taken with respect to the element can include, for example, removing, blocking out, highlighting, applying an opaque filter and/or colorizing.

### BACKGROUND

With an ever-increasing amount of content available to users via the Internet, user frustration with viewing non-desirable content has likewise increased. Conventionally, advertisement blockers have been employed which block advertisement(s) based upon a known source and/or name of a file associated with the advertisement.

### SUMMARY

Described herein is a system for filtering content, comprising: a computer comprising a processor and a memory having computer-executable instructions stored thereupon which, when executed by the processor, cause the computing device to: using a filter applying a model, based on content of an element of a received document, calculate a score indicative of whether the element comprises non-desired content; based upon the calculated score, determine that the element comprises non-desired content; and take an action with respect to the element based upon the determination that the element comprises non-desired content.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for filtering content.

FIG. 2 is a functional block diagram that illustrates a system for adapting a model.

FIG. 3 is a diagram that illustrates an example user interface.

FIG. 4 illustrates an example method of filtering content.

FIG. 5 illustrates an example method of adapting a model.

FIG. 6 illustrates an example method of filtering content.

FIG. 7 is a functional block diagram that illustrates an exemplary computing system.

### DETAILED DESCRIPTION

Various technologies pertaining to filtering an element (e.g., web browser element) of a document (e.g., web page) based upon a determined score indicative of whether the element comprises non-desirable content (e.g., probability) are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding filtering an element (e.g., web browser element) based upon a determined score indicative of whether the element comprises non-desirable content. What follows are one or more exemplary systems and methods.

Aspects of the subject disclosure pertain to the technical problem of taking an action (e.g., removing and/or blocking) with respect to element(s) of a document comprising non-desired content. The technical features associated with addressing this problem involve receiving a document comprising a plurality of elements, each of the plurality of elements comprising content such as text, image(s), video(s) and/or audio. The plurality of elements are filtered using a model (e.g., Naive Bayes classifier) to determine that at least one of the elements comprises non-desired content. Based upon this determination, an action (e.g., removing and/or blocking) is taken with respect to the element(s) determined to comprise non-desired content. Accordingly, aspects of these technical features exhibit technical effects of more efficiently and effectively filtering content, for example, allowing for display of a greater amount of relevant content to a user and/or reduced memory consumption .

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems and/or sub-systems) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

As used herein, “document” refers to a digital representation of information to be presented, for example, to a user. A document can include one or more elements of the same and/or dissimilar types. In some embodiments, a document can include text, image(s), video(s) and/or audio file(s). In some embodiments, a document can include reference(s) used to retrieve text, image(s), video(s) and/or audio file(s) (e.g., a collection of files loaded from one or more servers to render a web page). By way of example, a web page retrieved via the Internet is a document.

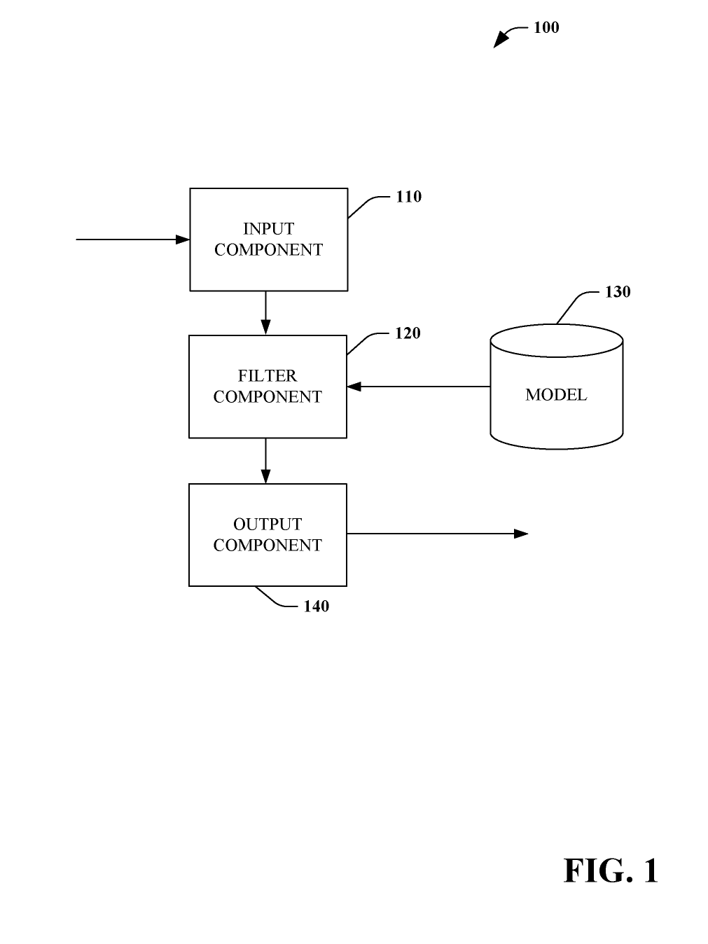

Referring to FIG. 1, a system for filtering content 100 is illustrated. Conventionally, web browser user(s) are confronted with a large number of elements of content (e.g., posts, pictures, text) much of which a particular user may find non-desirable (e.g., offensive and/or not relevant). In some embodiments, prior to presentation (e.g., display) of content (e.g., web content), the system 100 can determine which element(s) of a received document (e.g., web page) comprise non-desired content (e.g., a particular user would likely find to be non-desired) and takes an action (e.g., removing, blocking and/or graying) with regard to the determined element(s).

For example, in response to a user's request, the system 100 can receive a web page associated with a social networking site. In some embodiments, prior to displaying the web page, the system 100, can determine which post(s) include non-desired content for the particular user and take an action with regard to the determined post(s) (e.g., block). In some embodiments, the system 100 can determine which post(s) include non-desired content for the particular user and taken an action with regard to the determined post(s) (e.g., block) during and/or after displaying the web page.

In some embodiments, the system 100 is a component of a user's computer (e.g., as a plug-in to a web browser). In some embodiments, the system 100 is available as a service (e.g., cloud-based service) to a user (e.g., filtering performed remotely prior to information being sent to user's computer). In some embodiments, portion(s) of the system are resident on the user's computer and portion(s) of the system 100 are available as a service (e.g., cloud-based service).

The system 100 includes an input component 110, a filter component 120 utilizing a model 130 and an output component 140. The input component 110 receives a document (e.g., web page) comprising a plurality of elements having content (e.g., text, image(s), video(s) and/or audio file(s)).

The input component 110 can provide the received document and/or particular element(s) of the received document to the filter component 120 which uses the model 130 (e.g., statistical learning system such as a classifier) to filter the element(s) determined to likely comprise non-desired content. “Non-desired content” refers to text, image(s), video(s) and/or audio which the filter component 120 determines a user of the system 100 would likely not desire to be presented (e.g., displayed). In some embodiments, as discussed below, the model 130 can be adapted based on input received from a particular user. Based upon content of elements the particular user has previously indicated as non-desirable, the system 100 can calculate an approximate probability that an element of a newly received document (e.g., web page) comprises content which the particular user would likely not desire to be presented. In some embodiments, the filter component 120 can utilize a speech recognizer, an image recognizer and/or an audio recognizer.

In some embodiments, the input component 110 can utilize JavaScript and a jQuery element selector for determining elements within a document hierarchy of a received document in order to identify which element(s) within the received document (e.g., webpage) to provide to the filter component 120. In some embodiments, specific kind(s) of element(s) can be specified (e.g., hard-coded and/or user-specified) in order to minimize performance impacts of filtering objects (e.g., elements) in the document (e.g., webpage).

In some embodiments, particular element(s) to be filtered can be determined based upon computing resources available to the system 100. For example, in order to minimize user frustration during peak processing times, the input component 110 can selectively apply the filter component 120 to particular elements (e.g., randomly chosen, based upon storage size of particular element, based upon display area associated with particular element) and provide any remaining element(s) directly to the output component 140 for rendering on a display to the user.

In some embodiments, particular element(s) to be filtered can be determined based upon a context associated with a web browsing session. For example, when browsing a particular site and/or type of site (e.g., trusted site), a first element selection approach can be applied by the input component 140. However, when browsing a different particular site and/or different type of site (e.g., an other than trusted site), a second element selection approach can be applied by the input component 140.

In some embodiments, the filter component 120 applies a Naive Bayes classifier (e.g., model 130) which utilizes a stored frequency table of “desired” and “non-desired” counts of n-grams (e.g., single word, bi-gram, tri-gram) appearing in text associated with document object model (DOM) objects in a document (e.g., web pages). For example, the text can be associated with a social media post. These counts can be stored locally and, optionally, updated based on user feedback associated with displayed element(s), as discussed below. The filter component 120, applying the model 130 (e.g., Naive Bayes classifier) utilizes the stored frequency table to calculate an approximate probability a particular element (e.g., DOM object) comprises non-desired content. In some embodiments, when the calculated approximate probability that a particular element comprises non-desired content is greater than or equal to a threshold, the filter component 120 takes an action regarding the particular element (e.g., removing and/or blocking).

In some embodiments, the filter component 120 applies the model 130 using one or more machine learning algorithms including linear regression algorithms, logistic regression algorithms, decision tree algorithms, support vector machine (SVM) algorithms, Naive Bayes algorithms, a K-nearest neighbors (KNN) algorithm, a K-means algorithm, a random forest algorithm, dimensionality reduction algorithms, and/or a Gradient Boost & Adaboost algorithm.

In some embodiments, the filter component 120 applies a scoring algorithm (e.g., model 130) to calculate a score indicative of whether an element comprises non-desired content. In some embodiments, when the calculated score that a particular element comprises non-desired content is greater than or equal to a threshold, the filter component 120 takes an action regarding the particular element.

In some embodiments, the threshold is statically set (e.g., hard-coded). In some embodiments, the threshold can be user-configured based upon an aggressiveness to be applied to taking action with respect to potentially non-desired content. For example, a non-aggressive approach corresponds to a higher threshold, thus allowing for action to be taken for particular element(s) with a higher calculated approximate probability and/or score. An aggressive approach corresponds to a lower threshold, thus allowing for action to be taken for particular element(s) with a lower calculated approximate probability and/or score.

In some embodiments, the threshold can be dynamically configured, for example, based upon user feedback during a web browsing session. For example, in order to minimize user frustration, periodically and/or in response to user input, the system 100 can cause an input control associated with the threshold to be displayed to the user so that the user can dynamically alter the threshold.

In response to determining that a particular element comprises non-desired content, the output component 140 can take an action with respect to the particular element. In some embodiments, the particular element determined to comprise non-desired content is removed with the remainder of the received document is displayed. In some embodiments, the particular element determined to comprise non-desired content is visually distinguished (e.g., blocked-out, highlighted, opaque filter applied and/or colorization) from the remainder of the received document being displayed. In some embodiments, a user using an input device (e.g., a mouse input, touch input and/or touch pad input), can hover over the visually distinguished element in order to determine the content of the particular element to which the action was taken.

In some embodiments, a user can improve functioning of the system 100 by confirming and/or correcting the action taken by the system 100. For example, if the system 100 determines that a particular element should be hidden, the user can confirm that the particular element is to be hidden, thereby completely hiding the particular element. Alternatively, should the user correct the action taken by the system 100, the system 100 can reverse the action taken, causing the particular element to be displayed. In both scenarios, the system 100 can utilize the feedback from the user (e.g., confirmation or correction) to improve the stored model 130, as discussed below.

In some embodiments, the system 100 can take an action (e.g., highlight) regarding a particular element based on a lack of data regarding content of the particular element. Based upon feedback from the user (e.g., confirmation or correction), the system 100 can adapt the stored model 130, as discussed below.

In some embodiments, the action taken by the output component 140 is based upon the determined approximate probability that a particular element comprises non-desired content and/or score indicative of whether the particular element comprises non-desired content. For example, for a first element having determined probability greater than or equal to a first threshold, the first element can be removed by the output component 140. For a second element having a determined probability greater than or equal to a second threshold but less than the first threshold, the second element can be colorized (e.g., highlighted) when displayed, thus allowing the user to view the content associated with the second element.

In some embodiments, the action taken by the output component 140 is based upon a user-specified preference(s). In some embodiments, the action taken by the output component 140 is predetermined before a browsing session. In some embodiments, the action taken by the output component 140 is dynamically determined based upon user feedback during the browsing session.

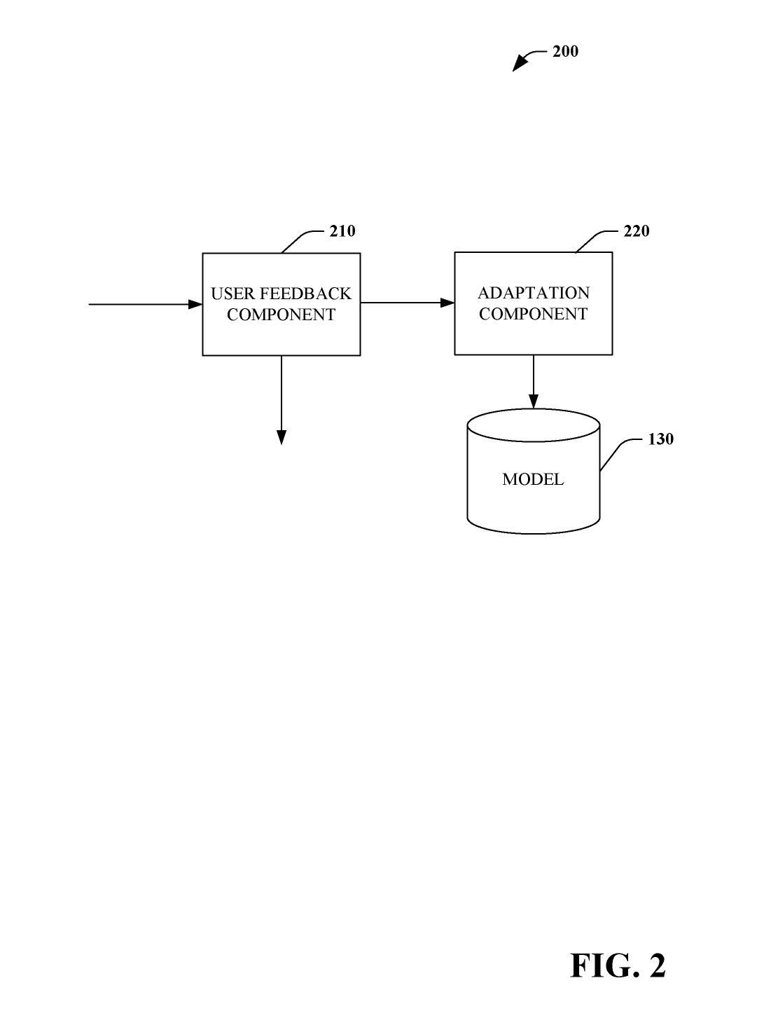

Turning to FIG. 2, a system for adapting a model 200 is illustrated. The system 200 can be used to adapt (e.g., update) the model 130 used by the filtering component 120 to calculate an approximate probability and/or score that a particular element comprises non-desired content. In some embodiments, the system 200 can be used by a particular user during a browsing session to initialize the model 130 (e.g., train the model 130) based upon preference(s) of the particular user. For example, prior to the system 100 being used to filter content, the system 200 can be utilized to customize the model 130 based upon feedback from the particular user. In some embodiments, the system 200 can be used by the particular user during a browsing session to update and/or adapt the model 130 based upon preference(s) of the particular user.

The system 200 includes a user feedback component 210 and an adaptation component 220. The user feedback component 210 provides a mechanism for a user to indicate whether or not a particular element of a displayed document (e.g., web page) comprises non-desired content. The user feedback component 210 can provide received user input indicating whether or not the particular element of the displayed document comprises non-desired content.

In some embodiments, the system 200 provides the mechanism for the user to indicate whether or not a particular element comprises non-desired content for all elements displayed to the user. In some embodiments, the system 200 provides the mechanism for the user to indicate whether or not a particular element comprises non-desired content for a predetermined quantity of elements (e.g., one element, n elements). In some embodiments, the system 200 determines which elements to provide the mechanism for the user to indicate whether or not a particular element comprises non-desired content based upon a display area of the particular element (e.g., largest n elements and/or smallest m elements).

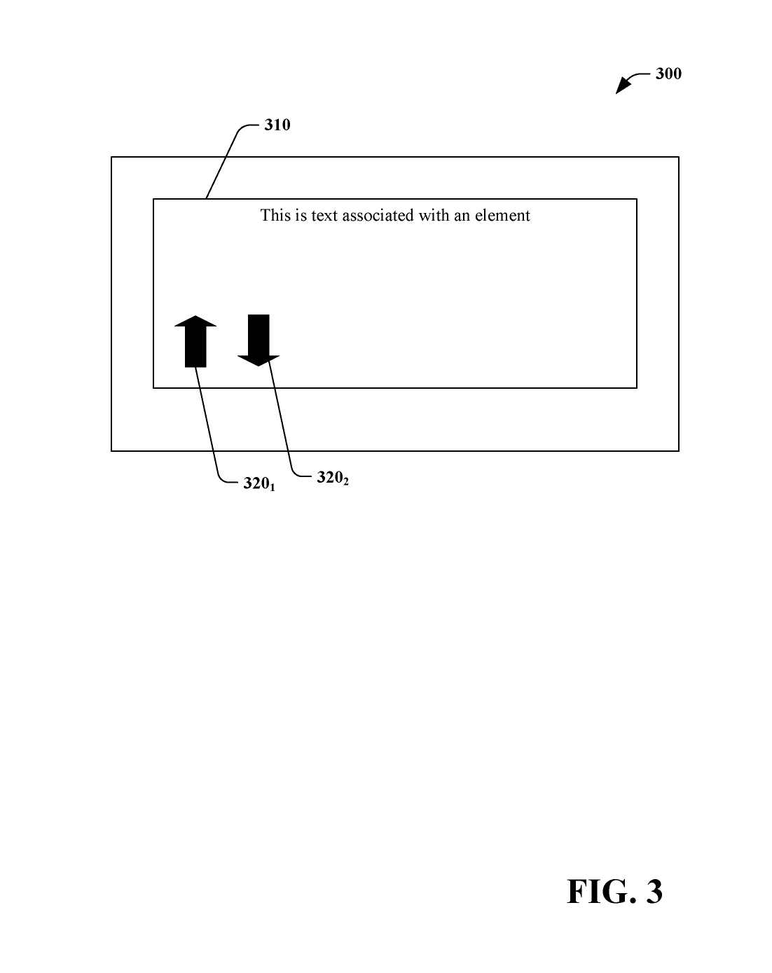

Turning briefly to FIG. 3, an example user interface 300 is illustrated. The user interface includes an overlay 310 displayed over a particular element of a document. The overlay 310 includes one or more indicators 320₁, 320₂. Using the indicators 320, a user can provide feedback to the user feedback component 210 regarding whether or not the particular element comprises non-desired content. This received user input and information associated with the particular element (e.g., text) can be provided to the adaptation component 220.

Referring back to FIG. 2, the adaptation component 220 can update/adapt the model 130 based upon the received user input. In some embodiments, the adaptation component 220 can update a frequency table stored in the model 130 of “desired” and “non-desired” counts of n-grams (e.g., single word, bi-gram, tri-gram.) appearing in text associated with the particular element. For example, based on a user indication of the particular element comprising non-desired text, using a bi-gram model with the text “This is text associated with an element”, the adaptation component 220 increases “non-desired” counts associated with word pairs “This is”, “is text”, “text associated”, “associated with”, “with an”, “an element”. In some embodiments, null anchor value(s) are also utilized (e.g., to add signal). For example, the adaptation component 220 can increase “non-desired” counts associated with pairs “{null} This” and “element {null}”.

In some embodiments, in addition to indicating that the particular element comprises non-desired content, the user feedback component 210 can receive information (e.g., a tag) from the user indicative of reason(s) for the indication (e.g., politics, marketing and/or sales). The additional information can be utilized in a privacy-preserving manner (e.g., removal of personally identifiable information) and with the user's explicit consent to allow other user(s) to benefit from the user's feedback. For example, a group of users can opt-in to sharing information (e.g., tags) associated with web content in order to adapt models 130 of each of the group of users local computer systems.

In some embodiments, the system 200 is utilized to adapt the model 130 in response to user input (e.g., request to adapt/train model 130). Thereafter, the adapted model 130 is used by the system 100 determine which element(s) of a received document comprise non-desired content (e.g., the user would likely find to be non-desired) and takes an action (e.g., removing, blocking and/or graying) with regard to the determined element(s).

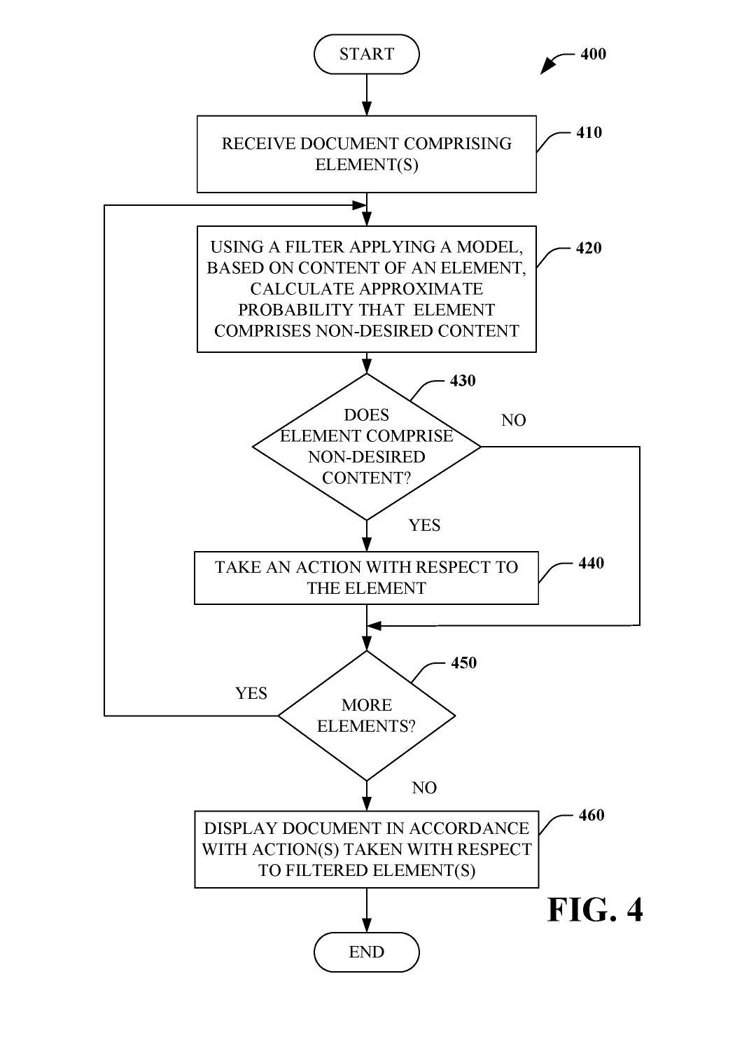

FIGS. 4-6 illustrate exemplary methodologies relating to filtering an element (e.g., web browser element) based upon a determined probability that the element comprises non-desirable content and/or calculated score indicative of whether the element comprises non-desirable content. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 4, a method of filtering content 400 is illustrated. In some embodiments, the method 400 is performed by system for filtering content 100. At 410, a document comprising elements is received. For example, the document can include text, image(s), video(s) and/or audio files.

At 420, using a filter applying a model, based on content of an element, an approximate probability that the element comprises non-desired content is calculated. In some embodiments, only specified kinds of element(s) are filtered in order to minimize performance impacts of scanning objects (e.g., elements) in the document (e.g., webpage).

In some embodiments, a Naïve Bayes classifier (e.g., model 130) utilizing a stored frequency table of “desired” and “non-desired” counts of n-grams (e.g., single word, bi-gram, tri-gram) is utilized to calculate an approximate probability a particular element (e.g., DOM object) comprises non-desired content.

At 430, a determination is made as to whether the element comprises non-desired content. For example, the determination can be based upon the calculated probability being greater than or equal to a threshold.

If the determination at 430 is NO, processing continues at 450. If the determination at 430, is YES, at 440, an action is taken with respect to the element (e.g., remove, blocked-out, highlighted, opaque filter applied and/or colorized).

At 450, a determination is made as to whether the document includes more elements. If the determination at 450 is YES, processing continues at 420. If the determination at 450 is NO, at 460, the document is displayed in accordance with the action(s) taken regarding the filtered element(s) (e.g., removed, blocked-out, highlighted, opaque filter applied and/or colorized).

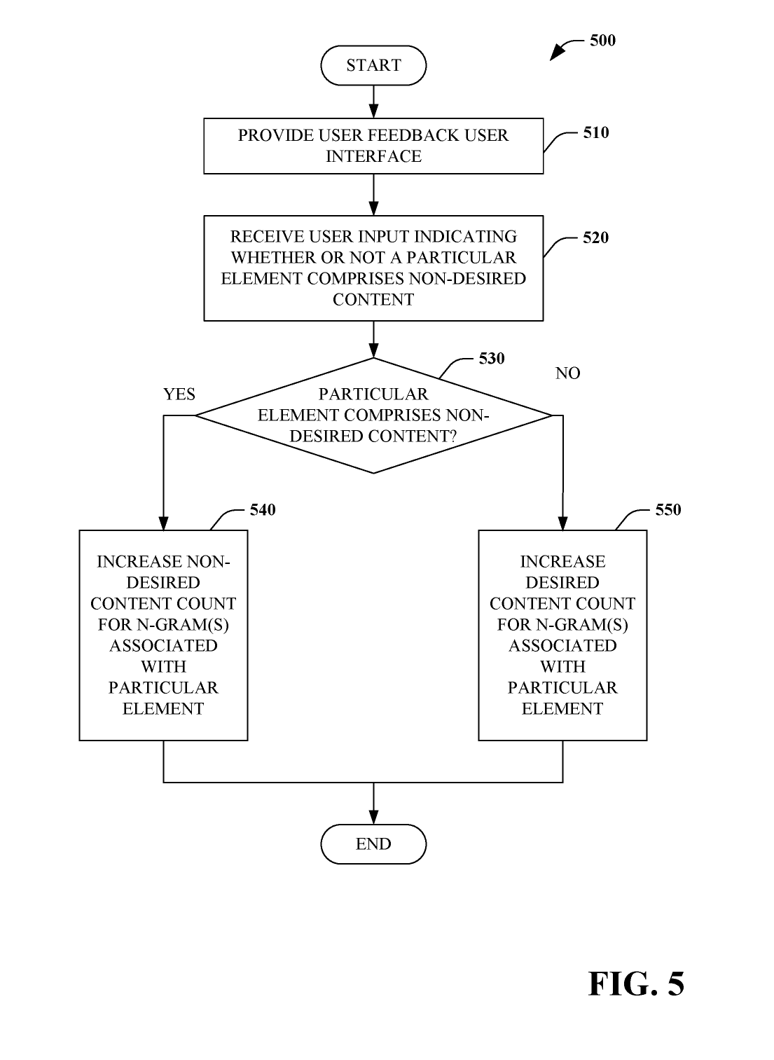

Turning to FIG. 5, a method of adapting a model 500 is illustrated. At 510, a user feedback interface is provided (e.g., displayed) to a user. At 520, user input regarding whether or not a particular element comprises non-desired content.

At 530, a determination is made as to whether the element comprises non-desired content. If the determination at 530 is YES, at 540, a non-desired count for n-gram(s) associated with the particular element is increased, and, no further processing occurs. If the determination at 530 is NO, at 550, a desired content count for n-gram(s) associated with the particular element is increased.

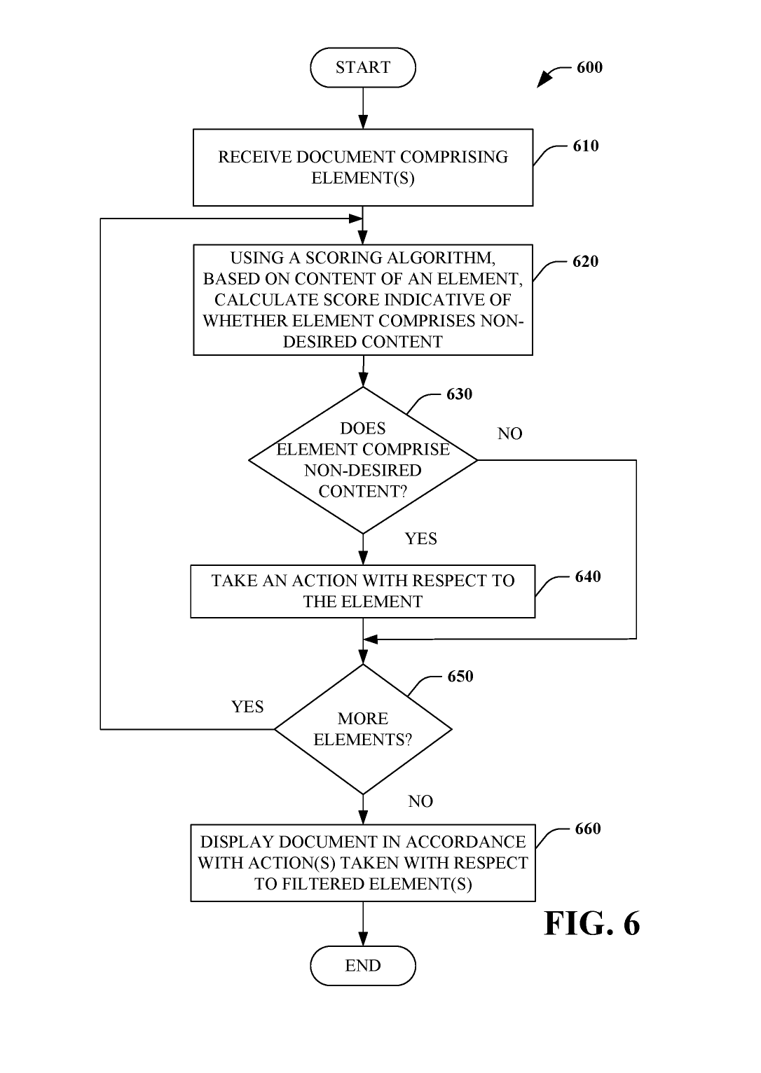

Next, referring to FIG. 6, a method of filtering content 600 is illustrated. In some embodiments, the method 600 is performed by system for filtering content 100. At 610, a document comprising elements is received. At 620, using a scoring algorithm, based on content of an element, a score indicative of whether the element comprises non-desired content is calculated. At 630, a determination is made as to whether the element comprises non-desired content. For example, the determination can be based upon the calculated score being greater than or equal to a threshold.

If the determination at 630 is NO, processing continues at 650. If the determination at 630, is YES, at 640, an action is taken with respect to the element (e.g., remove, blocked-out, highlighted, opaque filter applied and/or colorized).

At 650, a determination is made as to whether the document includes more elements. If the determination at 650 is YES, processing continues at 620. If the determination at 650 is NO, at 660, the document is displayed in accordance with the action(s) taken regarding the filtered element(s) (e.g., removed, blocked-out, highlighted, opaque filter applied and/or colorized).

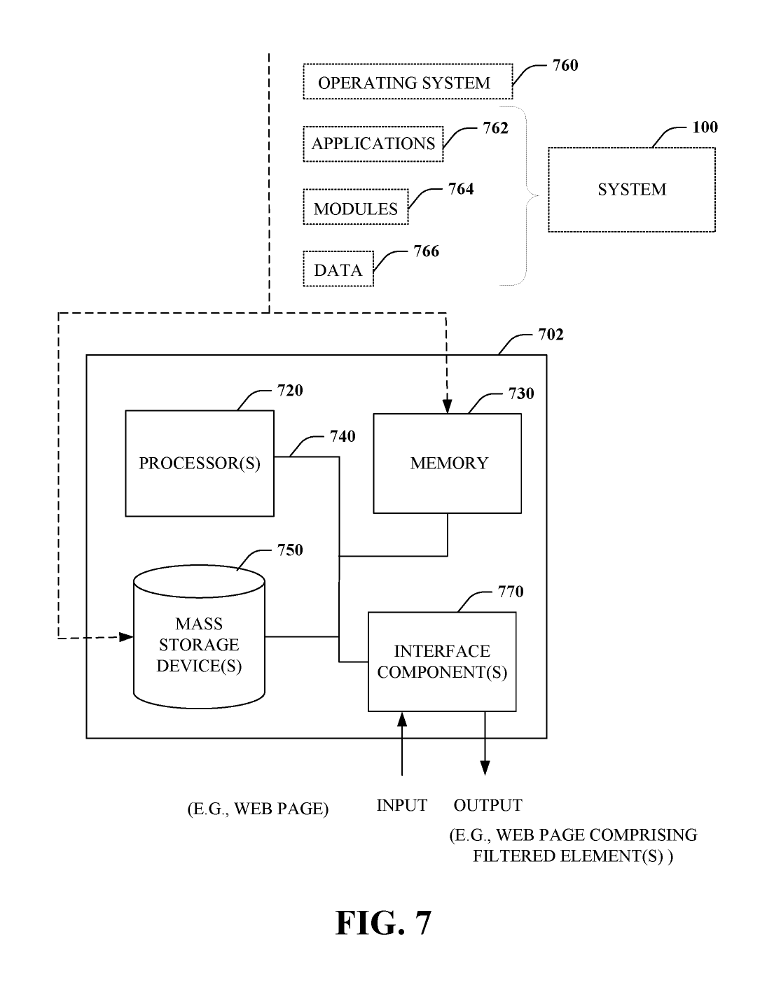

With reference to FIG. 7, illustrated is an example general-purpose computer or computing device 702 (e.g., mobile phone, desktop, laptop, tablet, watch, server, hand-held, programmable consumer or industrial electronics, set-top box, game system and/or compute node). For instance, the computing device 702 may be used in a system for filtering content 100.

Described herein is a system for filtering content, comprising: a computer comprising a processor and a memory having computer-executable instructions stored thereupon which, when executed by the processor, cause the computing device to: using a filter applying a model, based on content of an element of a received document, calculate a score indicative of whether the element comprises non-desired content; based upon the calculated score, determine that the element comprises non-desired content; and take an action with respect to the element based upon the determination that the element comprises non-desired content. The system can include the memory having further computer-executable instructions stored thereupon which, when executed by the processor, cause the computing device to: display the document in accordance with the action taken with respect to the element.

The system can further include wherein the computer-executable instructions are performed for a plurality of elements of the received document. The system can include wherein a quantity of the plurality of elements is user-configurable. The system can include wherein the plurality of elements are selected based upon a type associated with each of the plurality of elements.

The system can further include wherein a quantity of the plurality of elements is dynamically determined based upon computing resources available to the system. The system can include wherein the action taken comprises at least one of: removing the element from display of the document, blocking-out the element from display of the document, highlighting the element during display of the document, applying an opaque filter during display of the document or colorizing the element during display of the document. The system can further include wherein the model comprises a naive Bayes classifier that comprises a frequency table comprising a non-desired count and a desired count associated with n-grams.

The system can include the memory having further computer-executable instructions stored thereupon which, when executed by the processor, cause the computing device to: display a user feedback user interface in conjunction with display of a particular element; receive a user input indicating whether or not the particular element comprises non-desired content; when the user input indicates the particular element comprises non-desired content, increase the non-desired count associated with the n-grams of the particular element; and when the user input indicates the particular element comprises desired content, increase the desired count associated with the n-grams of the particular element.

Described herein is a method of filtering content, comprising: receiving a document comprising a plurality of elements, each element comprising content; for each of a quantity of the plurality of elements: using a filter applying a model, based upon content of the element, calculating a score indicative of whether an element comprises non-desired content; based upon the calculated score, determining whether or not the element comprises non-desired content; when it is determined that the element comprises non-desired content, taking an action with respect to the element based upon the determination that the element comprises non-desired content; and displaying the document in accordance with the action taken with respect to the element. The method can further include wherein the quantity is user-configurable.

The method can include wherein the quantity of the plurality of elements is selected based upon a type associated with each of the plurality of elements. The method can further include wherein the action taken comprises at least one of: removing the element before displaying the document, blocking-out the element during displaying the document, highlighting the element during display the document, applying an opaque filter during displaying the document or colorizing the element during displaying the document. The method can include wherein the model comprises a naive Bayes classifier. The method can further include displaying a user feedback user interface in conjunction with display of a particular element; receiving a user input indicating whether or not the particular element comprises non-desired content; and adapting the model based upon the received user input.

Described herein is a computer storage media storing computer-readable instructions that when executed cause a computing device to: using a classifier, based on content of an element of a received document, calculate a score indicative of whether the element comprises non-desired content; based upon the calculated score, determine that the element comprises non-desired content; and take an action with respect to the element based upon the determination that the element comprises non-desired content. The computer storage media can further store further computer-readable instructions that when executed cause a computing device to: display the document in accordance with the action taken with respect to the element.

The computer storage media can include wherein the action taken comprises at least one of: removing the element from display of the document, blocking-out the element from display of the document, highlighting the element during display of the document, applying an opaque filter during display of the document or colorizing the element during display of the document. The computer storage media can further include wherein the computer-readable instructions are performed iteratively for a plurality of elements of the received document. The computer storage media can include wherein a quantity of iterations is dynamically determined based upon available computing resources.

The computer 702 includes one or more processor(s) 720, memory 730, system bus 740, mass storage device(s) 750, and one or more interface components 770. The system bus 740 communicatively couples at least the above system constituents. However, it is to be appreciated that in its simplest form the computer 702 can include one or more processors 720 coupled to memory 730 that execute various computer executable actions, instructions, and or components stored in memory 730. The instructions may be, for instance, instructions for implementing functionality described as being carried out by one or more components discussed above or instructions for implementing one or more of the methods described above.

The processor(s) 720 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 720 may also be implemented as a combination of computing devices, for example a combination of a DSP and a microprocessor, a plurality of microprocessors, multi-core processors, one or more microprocessors in conjunction with a DSP core, or any other such configuration. In some embodiments, the processor(s) 720 can be a graphics processor.

The computer 702 can include or otherwise interact with a variety of computer-readable media to facilitate control of the computer 702 to implement one or more aspects of the claimed subject matter. The computer-readable media can be any available media that can be accessed by the computer 702 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM)), magnetic storage devices (e.g., hard disk, floppy disk, cassettes and/or tape), optical disks (e.g., compact disk (CD) and/or digital versatile disk (DVD)), and solid state devices (e.g., solid state drive (SSD), flash memory drive (e.g., card, stick and/or key drive), or any other like mediums that store, as opposed to transmit or communicate, the desired information accessible by the computer 702. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 730 and mass storage device(s) 750 are examples of computer-readable storage media. Depending on the exact configuration and type of computing device, memory 730 may be volatile (e.g., RAM), non-volatile (e.g., ROM and/or flash memory) or some combination of the two. By way of example, the basic input/output system (BIOS), including basic routines to transfer information between elements within the computer 702, such as during start-up, can be stored in nonvolatile memory, while volatile memory can act as external cache memory to facilitate processing by the processor(s) 720, among other things.

Mass storage device(s) 750 includes removable/non-removable, volatile/non-volatile computer storage media for storage of large amounts of data relative to the memory 730. For example, mass storage device(s) 750 includes, but is not limited to, one or more devices such as a magnetic or optical disk drive, floppy disk drive, flash memory, solid-state drive, or memory stick.

Memory 730 and mass storage device(s) 750 can include, or have stored therein, operating system 760, one or more applications 762, one or more program modules 764, and data 766. The operating system 760 acts to control and allocate resources of the computer 702. Applications 762 include one or both of system and application software and can exploit management of resources by the operating system 760 through program modules 764 and data 766 stored in memory 730 and/or mass storage device (s) 750 to perform one or more actions. Accordingly, applications 762 can turn a general-purpose computer 702 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 762, and include one or more modules 764 and data 766 stored in memory and/or mass storage device(s) 750 whose functionality can be realized when executed by one or more processor(s) 720.

In accordance with one particular embodiment, the processor(s) 720 can correspond to a system on a chip (SOC) or like architecture including, or in other words integrating, both hardware and software on a single integrated circuit substrate. Here, the processor(s) 720 can include one or more processors as well as memory at least similar to processor(s) 720 and memory 730, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 702 also includes one or more interface components 770 that are communicatively coupled to the system bus 740 and facilitate interaction with the computer 702. By way of example, the interface component 770 can be a port (e.g. serial, parallel, PCMCIA, USB and/or FireWire) or an interface card (e.g., sound and/or video) or the like. In one example implementation, the interface component 770 can be embodied as a user input/output interface to enable a user to enter commands and information into the computer 702, for instance by way of one or more gestures or voice input, through one or more input devices (e.g., pointing device such as a mouse, trackball, stylus, touch pad, keyboard, microphone, joystick, game pad, satellite dish, scanner, camera and/or other computer). In another example implementation, the interface component 770 can be embodied as an output peripheral interface to supply output to displays (e.g., LCD, LED and/or plasma), speakers, printers, and/or other computers, among other things. Still further yet, the interface component 770 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for filtering content, comprising:
a computer comprising a processor and a memory having computer-executable instructions stored thereupon which, when executed by the processor, cause the computing device to:
using a filter applying a model, based on content of an element of a received document, calculate a score indicative of whether the element comprises non-desired content;
based upon the calculated score, determine that the element comprises non-desired content; and
take an action with respect to the element based upon the determination that the element comprises non-desired content.

2. The system of claim 1, the memory having further computer-executable instructions stored thereupon which, when executed by the processor, cause the computing device to:
display the document in accordance with the action taken with respect to the element.

3. The system of claim 1, wherein the computer-executable instructions are performed for a plurality of elements of the received document.

4. The system of claim 3, wherein a quantity of the plurality of elements is user-configurable.

5. The system of claim 3, wherein the plurality of elements are selected based upon a type associated with each of the plurality of elements.

6. The system of claim 3, wherein a quantity of the plurality of elements is dynamically determined based upon computing resources available to the system.

7. The system of claim 1, wherein the action taken comprises at least one of: removing the element from display of the document, blocking-out the element from display of the document, highlighting the element during display of the document, applying an opaque filter during display of the document or colorizing the element during display of the document.

8. The system of claim 1, wherein the model comprises a naïve Bayes classifier that comprises a frequency table comprising a non-desired count and a desired count associated with n-grams.

9. The system of claim 8, the memory having further computer-executable instructions stored thereupon which, when executed by the processor, cause the computing device to:
display a user feedback user interface in conjunction with display of a particular element;
receive a user input indicating whether or not the particular element comprises non-desired content;
when the user input indicates the particular element comprises non-desired content, increase the non-desired count associated with the n-grams of the particular element; and
when the user input indicates the particular element comprises desired content, increase the desired count associated with the n-grams of the particular element.

10. A method of filtering content, comprising:
receiving a document comprising a plurality of elements, each element comprising content;
for each of a quantity of the plurality of elements:
using a filter applying a model, based upon content of the element, calculating a score indicative of whether an element comprises non-desired content;
based upon the calculated score, determining whether or not the element comprises non-desired content;
when it is determined that the element comprises non-desired content, taking an action with respect to the element based upon the determination that the element comprises non-desired content; and
displaying the document in accordance with the action taken with respect to the element.

11. The method of claim 10, wherein the quantity is user-configurable.

12. The method of claim 10, wherein the quantity of the plurality of elements is selected based upon a type associated with each of the plurality of elements.

13. The method of claim 10, wherein the action taken comprises at least one of:
removing the element before displaying the document, blocking-out the element during displaying the document, highlighting the element during display the document, applying an opaque filter during displaying the document or colorizing the element during displaying the document.

14. The method of claim 10, wherein the model comprises a naïve Bayes classifier.

15. The method of claim 10, further comprising:
displaying a user feedback user interface in conjunction with display of a particular element;
receiving a user input indicating whether or not the particular element comprises non-desired content; and
adapting the model based upon the received user input.

16. A computer storage media storing computer-readable instructions that when executed cause a computing device to:
using a classifier, based on content of an element of a received document, calculate a score indicative of whether the element comprises non-desired content;
based upon the calculated score, determine that the element comprises non-desired content; and
take an action with respect to the element based upon the determination that the element comprises non-desired content.

17. The computer storage media of claim 16, storing further computer-readable instructions that when executed cause a computing device to:
display the document in accordance with the action taken with respect to the element.

18. The computer storage media of claim 17, wherein the action taken comprises at least one of: removing the element from display of the document, blocking-out the element from display of the document, highlighting the element during display of the document, applying an opaque filter during display of the document or colorizing the element during display of the document.

19. The computer storage media of claim 16, wherein the computer-readable instructions are performed iteratively for a plurality of elements of the received document.

20. The computer storage media of claim 19, wherein a quantity of iterations is dynamically determined based upon available computing resources.
